(19) United States
(12) Patent Application Publication
(10) Pub. No.: US 2023/0008920 A1
(43) Pub. Date: Jan. 12, 2023

(54) SYSTEM CONFIGURATION INFORMATION MANAGEMENT DEVICE AND OPERATION INPUT DEVICE

(71) Applicants: KABUSHIKI KAISHA TOSHIBA, Minato-ku, Tokyo (JP); TOSHIBA INFRASTRUCTURE SYSTEMS & SOLUTIONS CORPORATION, Kawasaki-shi, Kanagawa (JP)

(72) Inventor: Genki TATENO, Hino, Tokyo (JP)

(73) Assignees: KABUSHIKI KAISHA TOSHIBA, Minato-ku, Tokyo (JP); TOSHIBA INFRASTRUCTURE SYSTEMS & SOLUTIONS CORPORATION, Kawasaki-shi, Kanagawa (JP)

(21) Appl. No.: 17/784,042

(22) PCT Filed: Dec. 7, 2020
(86) PCT No.: PCT/JP2020/045496

§ 371 Date: Jun. 9, 2022

(30) Foreign Application Priority Data
Dec. 12, 2019 (JP) 2019-224648
Jun. 12, 2020 (JP) 2020-102389

(51) Int. Cl. G05B 23/02; G05B 19/418

(52) U.S. Cl. CPC G05B 23/0272; G05B 19/41845; G05B 2219/25064

(57) ABSTRACT

A system configuration information management device includes a storage device configured to store therein control system identification information, component identification information, and version information in association with one another. The control system identification information identifies a control system. The component identification information identifies each of a plurality of components composing the control system. The version information indicates a version of an element of each of the components having at least hardware.

### FIELD

The present invention relates to a system configuration information management device and an operation input device.

### BACKGROUND

Conventionally, control systems that control industrial plants (hereinafter, also simply described as “plants”) such as water treatment facilities have been composed of a plurality of components coupled to one another via networks, for example. Those components include controllers that control instruments to be controlled such as vales on the basis of outputs of sensors in the plants and monitoring control devices (hereinafter, also described as “human machine interfaces (HMIs)” for operators to monitor execution status of the processing by the controllers, for example. The HMI, which outputs a control request to the controller on the basis of the operator’s operation input, for example, can also be described as an operation input device.

Versions of elements such as hardware, an operating system (OS), and software of each component influence the combination of the components composing the control system. For example, when the hardware and the OS of the HMI that have been in use for long time are failed and are renewed, the versions of the procurable hardware and OS are often the latest. In such a case, the latest version hardware and OS that are mounted in the HMI have new functions and influence also other components (e.g., the controller) of the control system in some cases.

For handing a trouble such as a component failure, version information about the elements of the other components than the failed component is also required. It is thus desired to manage the components and the version information about the elements of the components on a per control system basis.

In addition, when the components composing the control system and the versions of the elements of the components are changed, the information can be preferably renewed and managed.

### CITATION LIST

### Patent Literature

Patent Literature 1: Japanese Patent No. 5454102

### SUMMARY OF THE INVENTION

### Problem to Be Solved by the Invention

A problem to be solved by the invention is to provide: a system configuration information management device that can manage the components and the version information about the elements of the components on a per control system basis, the control system being used by a user; and an operation input device that can output information necessary to renew the components that are managed by the system configuration information management device and the version information about the elements of the components.

### Means for Solving Problem

A system configuration information management device according to an embodiment includes a storage device configured to store therein control system identification information, component identification information, and version information in association with one another. The control system identification information identifies a control system. The component identification information identifies each of a plurality of components composing the control system. The version information indicates a version of an element of each of the components having at least hardware.

An operation input device according to another embodiment includes a storage device, a collection module, and a detection module. The storage device is configured to store therein information including component identification information and version information in association with each other, the component identification information identifying each of a plurality of components composing a control system, and the version information indicating a version of an element of each of the components having at least hardware. The collection module is configured to collect the version information from each of the components composing the control system. The detection module is configured to detect a difference between the information stored in the storage device and information in which the component identification information is associated with the version information collected by the collection module.

### BRIEF DESCRIPTION OF DRAWINGS

FIG. 1 is a diagram illustrating a control system and a system configuration information management device according to a first embodiment.

FIG. 2 is a block diagram illustrating a hardware configuration of the system configuration information management device according to the first embodiment.

FIG. 3 is a diagram illustrating a data configuration of a customer information storage unit included in the system configuration information management device according to the first embodiment.

FIG. 4 is a diagram illustrating a data configuration of a contract information storage unit included in the system configuration information management device according to the first embodiment.

FIG. 5 is a diagram illustrating a data configuration of a system information storage unit included in the system configuration information management device according to the first embodiment.

FIG. 6 is a block diagram illustrating a functional configuration of the system configuration information management device according to the first embodiment.

FIG. 7 is a flowchart illustrating a registration processing flow by a control unit of the system configuration information management device according to the first embodiment.

FIG. 8 is a block diagram illustrating a hardware configuration of the control system according to the first embodiment.

FIG. 9 is a diagram illustrating a data configuration of a guidance DB storage unit included in an operation input device according to the first embodiment.

FIG. 10 is a diagram illustrating a data configuration of a self-information storage unit included in the operation input device according to the first embodiment.

FIG. 11 is a diagram illustrating a data configuration of a component information storage unit included in the operation input device according to the first embodiment.

FIG. 12 is a diagram illustrating a data configuration of a contract information storage unit included in the operation input device according to the first embodiment.

FIG. 13 is a block diagram illustrating a functional configuration of the operation input device according to the first embodiment.

FIG. 14 is a diagram illustrating a component information-contract information display screen of the operation input device according to the first embodiment.

FIG. 15 is a diagram illustrating a guidance display screen of the operation input device according to the first embodiment.

FIG. 16 is a flowchart illustrating a component information renewal processing flow by a control unit of the operation input device according to the first embodiment.

FIG. 17 is a diagram illustrating a notification screen of the operation input device according to the first embodiment.

FIG. 18 is a diagram illustrating a data configuration of the contract information storage unit of the operation input device in a modification.

FIG. 19 is a diagram illustrating a component information-contract information display screen of the operation input device in the modification.

FIG. 20 is a diagram illustrating a data flow in the control system according to a second embodiment.

FIG. 21 is a diagram illustrating a data flow in the control system according to a third embodiment.

FIG. 22 is a diagram illustrating a data flow in the control system according to a fourth embodiment.

FIG. 23 is a diagram illustrating an outline of the control system according to a fifth embodiment.

### DETAILED DESCRIPTION

The following describes a system configuration information management device and a control system according to embodiments with reference to the accompanying drawings. The control system includes an HMI, which is an example of an operation input device. After a second embodiment onwards, the same descriptions described in the previous embodiments are omitted as appropriate.

### First Embodiment

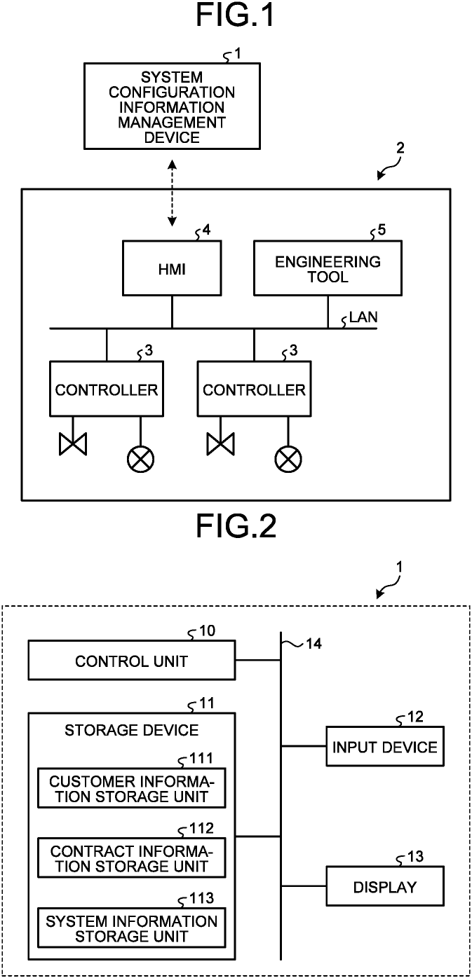

FIG. 1 is a diagram exemplarily illustrating a system configuration information management device and a control system according to a first embodiment. A system configuration information management device 1 is managed by a vendor that provides components composing a control system 2 to a user of the control system 2. Providing the components includes selling and lending the components to the user by the vendor.

The control system 2, which is the control system controlling a plant, for example, is used by the user that manages the plant. In the first embodiment, a case is described where the user uses the whole or a part of the components of the control system 2 on lease from the vendor by a lease contract (hereinafter, also simply described as a contract). The use is not limited to the case. The system configuration information management device 1 and the control system 2 can be also applied to a case where the user purchases each of the components from the vendor and uses them. Even in both cases, when a trouble occurs in the control system 2, the vendor deals with the trouble.

The control system 2 has controllers 3, an HMI 4, and an engineering tool 5. The controllers 3, the HMI 4, and the engineering tool 5 are coupled to one another such that mutual communication can be made with a local area network (LAN). The controllers 3 and the HMI 4 are examples of the components composing the control system 2. The components are each constituted of elements such as hardware and software (including an OS), and each have at least the hardware. The numbers of controller 3 and HMI 4 are set appropriately in accordance with the plant that uses the control system 2.

The controllers 3 each control the instrument to be controlled such as a valve on the basis of outputs of sensors in the plant. The HMI 4, which is provided for an operator to monitor an execution status of the processing by the controllers 3, outputs a control request to the controller 3, for example, when the operator operates the HMI 4 as needed. The engineering tool 5 produces control programs to be executed by the controllers 3, for example.

The details of the system configuration information management device 1 and the control system 2 are described later. The information (information about a contract, information about a component, and the like) output by the system configuration information management device 1 is input into the HMI 4.

The following describes the system configuration information management device 1 in detail. The system configuration information management device 1 manages various types of information about each component composing the control system on a per control system basis. Examples of the various types of information include component identification information (hereinafter, also described as a component ID) that identifies the component, version information about the elements constituting the component, and information about a contract of the component. FIG. 2 is a diagram illustrating a hardware configuration of the system configuration information management device 1.

The system configuration information management device 1 includes a control unit 10, a storage device 11, an input device 12, and a display 13. The control unit 10, the storage device 11, the input device 12, and the display 13 are coupled to one another via a bus 14, for example. The system configuration information management device 1 may include a communication interface to be capable of communicating with the control system 2.

The control unit 10 includes a computer that includes a central processing unit (CPU), a read only memory (ROM), and a random access memory (RAM), which are not illustrated. The control unit 10 executes various types of control processing of the system configuration information management device 1 as a result of the operation of the CPU according to the control program that is stored in the ROM and developed on the RAM.

The storage device 11 includes a storage device such as a hard disk drive (HDD), for example. The storage device 11 includes a customer information storage unit 111, a contract information storage unit 112, and a system information storage unit 113.

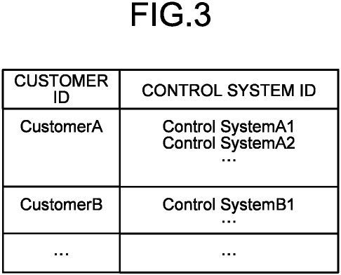

As illustrated in FIG. 3, the customer information storage unit 111 is a storage area in which user information (hereinafter, also described as a customer ID) that identifies the user of the control system 2, and control system identification information (hereinafter, also described as a control system ID) that identifies the control system 2 are stored in association with each other. The control system ID is assigned to a plurality of input component IDs.

The contract information storage unit 112 is a storage area in which the component identification information and information indicating an expiry date of a contract period are stored in association with each other. Specifically, the contract information storage unit 112 is the storage area in which information about the contract between the vendor and the user is stored for each component.

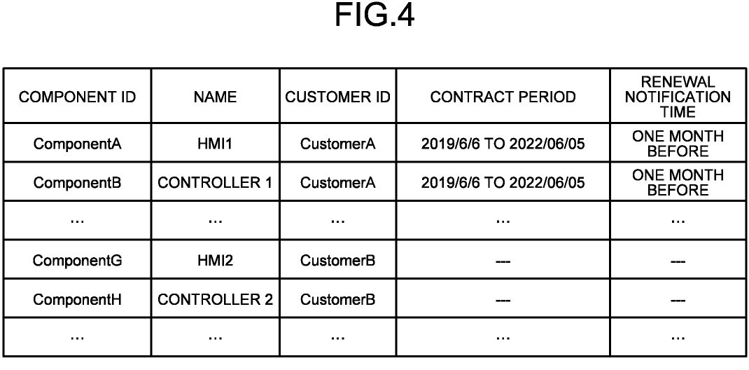

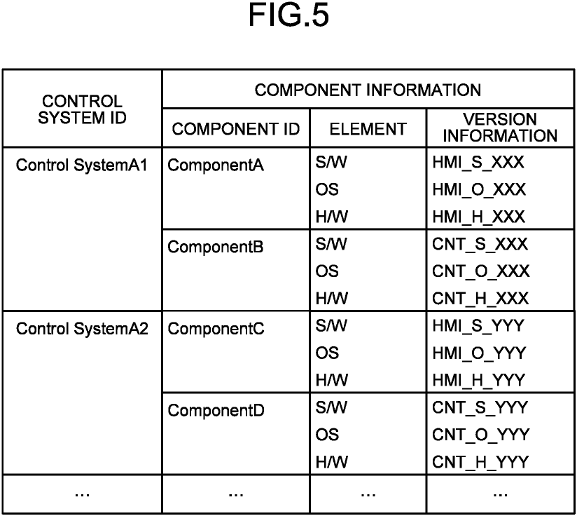

As illustrated in FIG. 4, the contract information storage unit 112 is a storage area in which the component ID, the name, the customer ID, the contract period, and the renewal notification time are stored in association with one another. The component ID, which is the information identifying the component, is an example of the component identification information. The name is the information that indicates the name of the component and is set to be easily understood by the vendor using the system configuration information management device 1. The customer ID is the information as described above. The contract period, which is the information indicating the contract period of the contract of the component, is an example of the information indicating the expiry date of the contract period. The renewal notification time is the information indicating a time at which the expiry date of the contract is notified to the vendor. In FIG. 4, the components G and H, in association with which no information about the contract period and the renewal notification time is stored, have been purchased by the customer.

The system information storage unit 113 is the storage area in which the control system identification information identifying the control system, the component identification information identifying each of the components composing the control system, and the version information indicating the versions of the elements of the component having at least the hardware are stored in association with one another. Specifically, in the system information storage unit 113, as illustrated in FIG. 5, the control system ID, the component ID, the information indicating the elements, and the version information are stored in association with one another.

The control system ID, which is the information identifying the control system 2 the user uses, as described above, is an example of the control system identification information. The component ID, which is the information identifying the component used in the control system 2, is unique information indicating the component such as a serial number. The element is the information indicating any of the software, the OS, and the hardware that constitute the component. The version information is the information indicating the versions of the elements. Hereinafter, the information that associates the component ID, the information indicating the elements, and the version information with one another is described as component information in some cases. The information that associates the control system ID with the component information about each component is described as system information in some cases.

The system configuration information management device 1 including the system information storage unit 113 allows the vendor to manage the components and the version information about the elements of the components on a per control system basis.

Referring back to FIG. 2, the input device 12 includes a keyboard, a mouse, and a reader that reads information from a medium in which various types of information are recorded. The display 13 is a display device that displays various types of information.

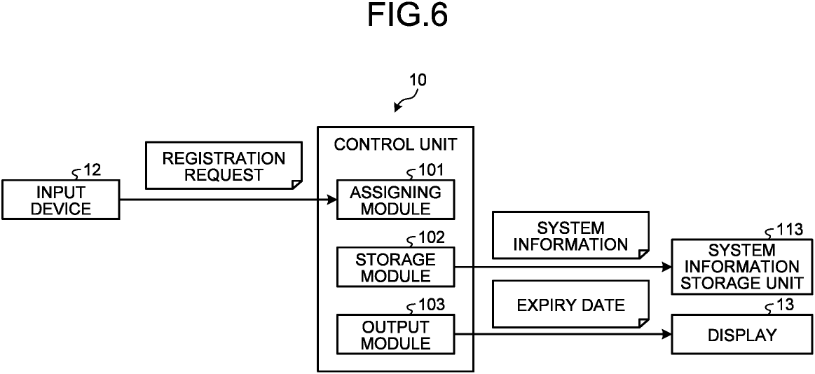

The following describes a functional configuration of the system configuration information management device 1. FIG. 6 is a block diagram illustrating an exemplary functional configuration of the system configuration information management device 1. The control unit 10 functions as an assigning module 101, a storage module 102, and an output module 103 as a result of the operation of the CPU according to the control program stored in the ROM. Each function may be achieved by hardware.

The assigning module 101 assigns the control system ID to the component IDs input into the input device 12, for example. Specifically, the assigning module 101 assigns the control system ID to the component IDs included in a registration request input into the input device 12. The registration request requests the assignment of the control system ID to the control system 2 composed of the components.

When any of the components identified by the component IDs included in the registration request is related to the contract, the assigning module 101 determines whether the user has an authority to use the component and then assigns the control system ID to the component. Specifically, the assigning module 101 determines whether the component identified by the component ID included in the input registration request is under the contract on the basis of the contract information storage unit 112. When the component is under the contract, the assigning module 101 determines whether the contract has a remaining contract period, and when the contract has a remaining contract period, the assigning module 101 assigns the control system ID to the component ID.

In the first embodiment, the registration request includes the component information in which each component ID, the information indicating the elements, and the version information are associated with one another. When the vendor manages the version information about the elements for each component on the basis of the contract of the component, for example, the registration request may include the component ID.

The registration request is input into the system configuration information management device 1 on the basis of application from the user when the user newly introduces the control system 2, for example. The registration request is input, through paper or an electric media, by the vendor that receives the provision of the component IDs from the user. The registration request may be input from the control system 2 coupled to the system configuration information management device 1 via a network.

The storage module 102 stores (registers), in the system information storage unit 113, the system information in which the control system ID and the component information included in the input registration request are associated with each other. When a renewal request including the component information is input into the control unit 10, the storage module 102 renews the system information storage unit 113 on the basis of the component information included in the renewal request. The renewal request is input on the basis of the information from the user when the user upgrade the software of the component by itself after the introduction of the control system 2, for example. Renewing the system information storage unit 113 includes a case where the component information stored in the system information storage unit 113 is overwritten or a case where the component information is added and stored in the system information storage unit 113.

The output module 103 outputs the system information stored in the system information storage unit 113. For example, the output module 103 outputs the system information to the display 13. This allows the display 13 to display, to the vendor, each component and the version information about the elements of the component on a per control system basis. The output module 103 extracts the component corresponding to the renewal notification time from the contract information storage unit 112 that stores therein the renewal notification time of the contract of each component, and outputs information indicating the expiry date of the contract of the extracted component. This allows the display 13 to display the contract having a near expiry date to the vendor.

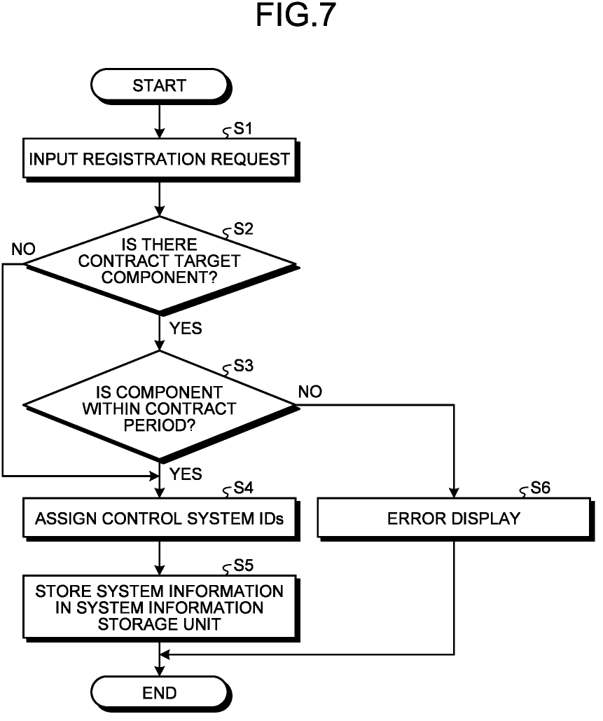

The following describes registration processing by the control unit 10 of the system configuration information management device 1. FIG. 7 is a flowchart illustrating a registration processing flow by the control unit 10 of the system configuration information management device 1. The registration processing, which stores the system information, is performed when the user introduces the control system 2, for example.

When the registration request is input (S1), the assigning module 101 determines whether each component identified by the component ID included in the registration request is a contract target component on the basis of the information stored in the contract information storage unit 112 (S2).

If there is a contract target component (Yes at S2), the assigning module 101 determines whether the contract target component is within the contract period (S3). If all the contract target components are within the respective contract periods (Yes at S3), the assigning module 101 assigns the control system IDs to the component IDs included in the registration request (S4). If there is no contract target component at the processing at S2 (No at S2), the control unit 10 skips the processing at S3, and proceeds to the processing at S4.

The storage module 102 stores, in the system information storage unit 113, the system information in which the control system ID assigned by the assigning module 101 and the component information included in the registration request are associated with each other (S5), and ends the registration processing. Meanwhile the storage module 102 stores the control system ID in the customer information storage unit 111.

If the contracts do not have remaining contract periods at the processing at S3 (No at S3), the output module 103 outputs information indicating an error display to the display 13 (S6), and ends the registration processing. The display 13 displays that the contract periods of the contracts of the components each having the component ID included in the input registration request have been expired.

As a result of the registration processing, the system information is stored in the system information storage unit 113. This allows the vendor managing the system configuration information management device 1 to manage the components and the version information about the elements of the components on a per control system basis, in other words, for each control system.

The following describes a notification method of the expiry date of the contract. The control unit 10 watches the contract period and the renewal notification time of the contract information stored in the contract information storage unit 112, and outputs, to the display 13, for example, the information indicating the contract expiry date (e.g., the contract period and the contract expiry date) about the contract reaching the renewal notification time. This allows the vendor to grasp the contract expiry date and to urge the user to renew the contract. The renewal of the contract may be directly urged to the user by coupling the system configuration information management device 1 and the control system 2 the user uses with a network and outputting the information indicating the contract expiry date to the HMI 4, for example.

As described above, the system configuration information management device 1 in the first embodiment includes the storage device that stores therein the control system identification information identifying the control system, the component identification information identifying each of the components composing the control system, and the version information indicating the versions of the elements of the component having at least hardware in association with one another.

This allows the vendor to grasp and manage the components and the versions of the elements of the components on a per control system basis. When a trouble occurs such as a failure of any of the components and the component is renewed, the vendor can grasp the versions of the elements of the other components and quickly deal with the renewal.

The system configuration information management device 1 in the first embodiment includes the assigning module that assigns the control system identification information to the input plurality of pieces of component identification information. The storage device stores therein the control system identification information assigned by the assigning module, the component identification information, and the version information.

The system configuration information management device 1 can store therein the information to manage the components and the elements of the components on a per control system basis by inputting a plurality of pieces of component identification information composing the control system 2.

Furthermore, the storage device of the system configuration information management device 1 in the first embodiment stores therein the component identification information in association with the information indicating the expiry date of the contract period.

This allows the vendor to check the expiry date of the contract period of the component as needed. This allows the vendor to urge the user to renew the contract of the component. As a result, this makes it possible to prevent the user from forgetting to renew the contract.

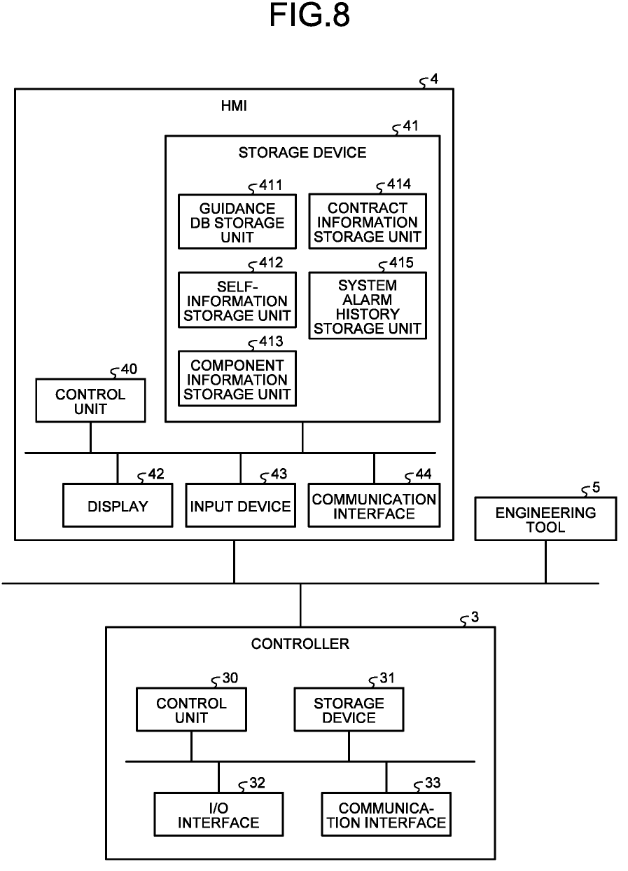

The following describes the control system 2 in detail. FIG. 8 is a block diagram illustrating a hardware configuration of the control system 2. As described above, the control system 2 includes the controllers 3, the HMI 4, and the engineering tool 5. The engineering tool 5 includes a personal computer (PC).

The controller 3 includes a control unit 30, a storage device 31, an I/O interface 32, and a communication interface 33. The control unit 30, the storage device 31, the I/O interface 32, and the communication interface 33 are coupled to one another via a bus 34.

The control unit 30 includes a computer including a CPU, a ROM, and a RAM. The control unit 30 executes the various types of processing of the controllers 3 as a result of the operation of the CPU according to the control program that is stored in the ROM and developed in the RAM.

The storage device 31 includes a storage device such as an HDD. The storage device 31 stores therein the various types of information about the controllers 3. For example, the storage device 31 stores therein the component IDs of the controllers 3 and the version information about the elements of the controllers 3.

The I/O interface 32 exchanges information with the instruments to be controlled and various sensors in the plant. The communication interface 33 communicates with the HMI 4 and the engineering tool 5 via the LAN.

The following describes the HMI 4. The HMI 4 includes a control unit 40, a storage device 41, a display 42, an input device 43, and a communication interface 44. The control unit 40, the storage device 41, the display 42, the input device 43, and the communication interface 44 are coupled to one another via a bus 45.

The HMI 4 is the device that is used for the operator to monitor the status of processing executed by the controllers 3. The HMI 4 displays, on the display 42, the execution status of the processing by the controllers 3 that control the instruments. The HMI 4 also displays a guidance that is displayed at a predetermined time, and a guidance that is displayed when an alarm indicating abnormality is received from the controller 3, for example. The operator of the HMI 4 can take necessary action in accordance with the displayed guidance.

The control unit 40 includes a computer including a CPU, a ROM, and a RAM. The control unit 40 executes various control processing by the HMI 4 as a result of the operation of the CPU according to the control program that is stored in the ROM and developed in the RAM.

The storage device 41, which includes a storage device such as an HDD, includes a guidance DB storage unit 411, a self-information storage unit 412, a component information storage unit 413, a contract information storage unit 414, and a system alarm history storage unit 415.

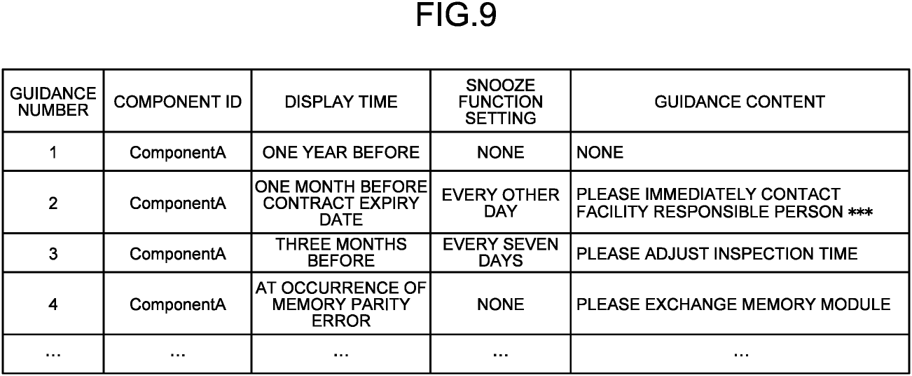

The guidance DB storage unit 411 stores therein a guidance DB that is set by the engineering tool 5 and downloaded to the HMI 4. In the guidance DB, a display time at which the HMI4 performs guidance display. In the first embodiment, a display time at which the contract information is displayed is also set in the guidance DB, and the contract information reaching the display time is displayed. This makes it possible to display the contract information using the mechanism for the HMI 4 to perform the guidance display. As illustrated in FIG. 9, the guidance DB storage unit 411 is a storage area in which the guidance number, the component ID, the display time, the snooze function setting, and the guidance content are stored in association with one another.

The guidance number is the information identifying the guidance content. The component ID, which is the information to identify the component used in the control system 2, is unique information indicating the component, such as the serial number, for example.

The display time is the information indicating the time at which the guidance is displayed. In other words, the display time is the information indicating the condition to display the guidance. The snooze function setting is the information indicating whether the snooze function is adopted, and a guidance display interval when the snooze function is adopted. The guidance content is the information indicating the content of the displayed guidance. When each guidance is displayed, it is set that the contract period is also displayed.

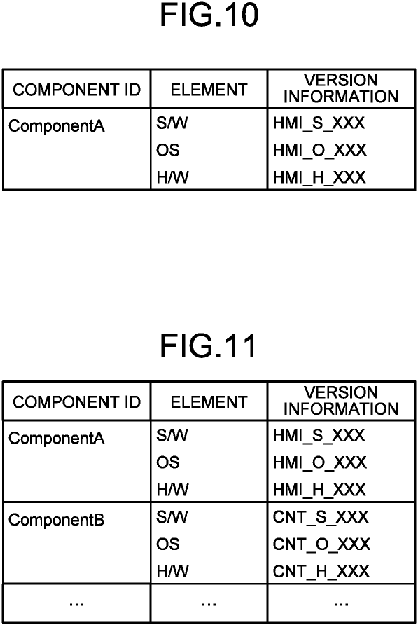

The self-information storage unit 412 is the storage area in which the component information about the self-device (HMI 4) is stored. Specifically, as illustrated in FIG. 10, the self-information storage unit 412 stores therein the component ID, and the elements of the HMI 4, and the version information about the elements, in association with one another. The component ID is already explained in the explanation of the guidance DB storage unit 411. The element is the information indicating any of the software, the OS, and the hardware that constitute the component. The version information indicates the version of each element. The storing in the self-information storage unit 412 may be done by the operator’s input or by the function of the control unit 40.

The component information storage unit 413 is the storage area in which the component identification information identifying each of the components composing the control system and the version information indicating the versions of the elements of the component having at least the hardware are stored in association with each other.

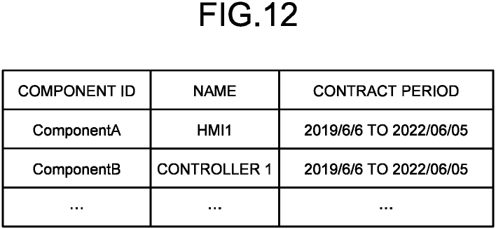

As illustrated in FIG. 11, the component information storage unit 413 stores therein the component information about each of the components composing the control system 2. Specifically, the component information storage unit 413 stores therein the version information stored in the self-information storage unit 412 and the version information about other components (e.g., the controllers 3), for example. As a result, the user can manage the components composing the control system 2 and the version information about the elements of the components in an integrated fashion manner. The component information stored in the component information storage unit 413 is input from the input device 43. The component information may be received from the system configuration information management device 1 by coupling the system configuration information management device 1 to the HMI 4 via a network.

The contract information storage unit 414 is the storage area in which the contract period of the contract of each component of the control system 2 is stored. Specifically, as illustrated in FIG. 12, the contract information storage unit 414 stores therein the component ID, the name, and the contract period, in association with one another. The component ID and the name are the information as described above. The contract period is the information indicating the period of the contract of the component.

Referring back to FIG. 8, the system alarm history storage unit 415 is the storage area in which a history of occurrence of the system alarm (e.g., occurrence date and time of the system alarm) notified from the component (e.g., the controller 3) in the control system 2 is stored.

The display 42 is a display device that displays various types of information. The input device 43 includes a keyboard, a mouse, and a reader that reads information from a medium in which various types of information are recorded. The communication interface 44 communicates with the controllers 3 and the engineering tool 5 via the LAN.

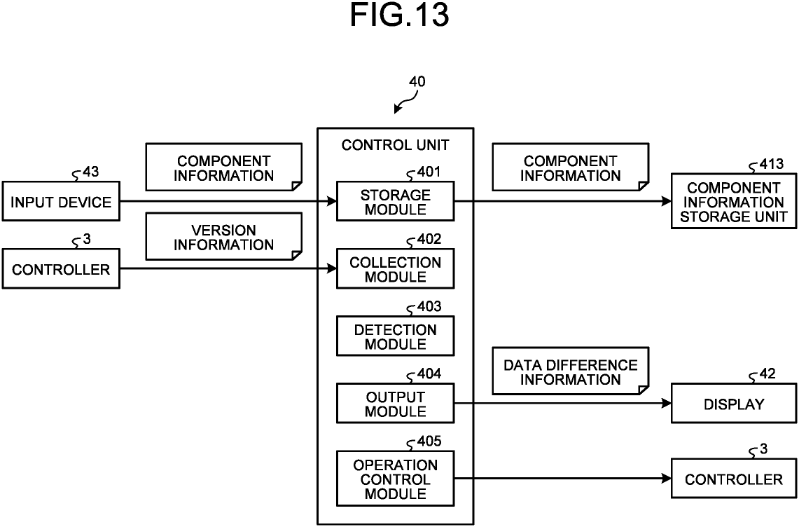

The following describes a functional configuration of the HMI 4. FIG. 13 is a block diagram illustrating an exemplary functional configuration of the HMI 4. The control unit 40 functions as a storage module 401, a collection module 402, a detection module 403, an output module 404, and an operation control module 405 as a result of the operation of the CPU according to the control program stored in the ROM. Each function may be achieved by hardware.

The storage module 401 stores, in the component information storage unit 413, the component information about each of the components composing the control system 2, the component information being input in the input device 43. The component information input in the input device 43 is provided from the vendor on the basis of the information output from the system configuration information management device 1, for example. Specifically, the component information about the components composing the control system 2 including the HMI 4 is output from the system information managed by the system management device 1, and provided to the user. The component information about each component may be received from the system configuration information management device 1 by coupling the HMI 4 to the system configuration information management device 1 via a network.

The collection module 402 collects the version information about the elements from each of the components composing the control system 2. Specifically, the collection module 402 outputs a request for the version information about the elements to each component coupled via the LAN periodically at preliminarily determined timing (e.g., once a day), and collects the version information about the elements from each component as a response to the request. Without the request output from the collection module 402, each component may periodically transmit the own component ID and the version information about the elements.

The detection module 403 detects a difference between the information stored in the component information storage unit 413 and the information in which the component identification information is associated with the version information collected by the collection module 402. Specifically, the detection module 403 compares the component ID stored in the component information storage unit 413 with the component ID associated with the version information collected by the collection module 402 to detect the difference between the component IDs. The detection module 403 compares the version information stored in the component information storage unit 413 with the version information collected by the collection module 402 to detect the difference between the two pieces of version information. The detection module 403 detects the difference described above each time the collection module 402 collects the version information.

The followings are cases where the difference occurs between the information stored in the component information storage unit 413 and the information in which the component identification information is associated with the version information collected by the collection module 402. After the component information is stored in the component information storage unit 413, when the component composing the control system 2 is added (case (1)), when the component composing the control system 2 is deleted (case (2)), and when the version of the element of the component composing the control system 2 is changed (case (3)). The detection module 403 detects the difference in component identification information in cases (1) and (2). The detection module 403 detects the difference in version information in case (3).

The output module 404 outputs information indicating the difference detected by the detection module 403. For example, the output module 404 outputs the information indicating the difference to the display 42. The display 42 displays the latest component information for the user. This allows the user to notify the vendor of the latest component information. The vender received the notification from the user can renew the system information about the system configuration information management device 1 to manage the latest component information.

The output module 404 outputs, to the display 42, the contract information indicating the expiry date of the contract of each component, the contract information being stored in the contract information storage unit 414. For example, the output module 404 outputs the contract information to the display 42 in response to the user’s request. The output module 404 outputs, to the display 42, the contract information of the component reaching the display time stored in the guidance DB storage unit 411.

The operation control module 405 controls the operation of the component after the expiry date of the contract period on the basis of extension information that indicates whether the component is usable after the expiry date of the contract period. The details of the operation control module 405 are described in a modification described later.

The following describes the operation of the HMI 4 thus configured. First, operation of component information-contract information display is described. The display 42 displays the component information and the contract information on the basis of the request from the operator of the HMI 4. FIG. 14 is a diagram illustrating an example of a component information-contract information display screen G2. When the instruction of component information-contract information display is input in the input device 43, the control unit 40 causes the display 42 to display the component information-contract information display screen G2 illustrated in FIG. 14 on the basis of the information stored in the component information storage unit 413 and the contract information storage unit 414.

This allows the operator to check the component information about each component composing the control system 2 and the information about the contract of each component as needed. The component information-contract information display screen G2 displays a file output button 421. When output is instructed by the file output button 421, the control unit 40 instructs an external device such as a printer (not illustrated) to output the content displayed on the component information-component information display screen G2.

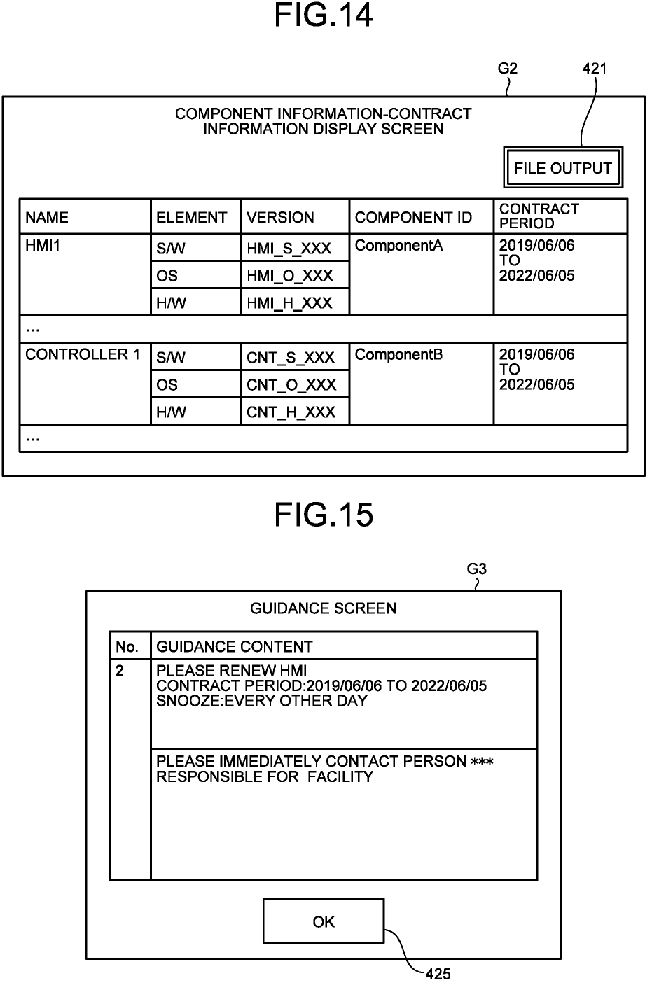

The following describes guidance display operation to urge contract renewal. The display 42 performs guidance display to urge contract renewal. FIG. 15 is a diagram illustrating an example of a guidance screen G3. The output module 404 reads the contract information about the component reaching the display time (e.g., one month before the contract expiry date) stored in the guidance DB storage unit 411, and outputs screen information including the contract information to the display 42.

The display 42 displays the guidance screen G3. FIG. 15 is the display corresponding to the number 2 in the guidance DB storage unit 411. The display 42 displays the contract period in addition to the guidance content stored in the guidance DB storage unit 411. The contract period is an example of the information indicating the expiry date.

The guidance screen G3 includes an OK button 422 that can instruct closing the guidance screen G3. When the operator operates the OK button 422 to instruct closing the guidance screen G3, the control unit 40 ends the display of the guidance screen G3. When the snooze function is set in the guidance database, the control unit 40 repeats displaying the guidance screen G3 on the display 42 on the basis of the setting of the snooze function (e.g., every other day). This allows the operator to grasp the component having a near contract renewal time.

The following describes renewal operation of the component information. FIG. 16 is a flowchart illustrating a component information renewal processing flow by the control unit 40. The component information renewal processing is performed every time the collection module 402 collects the component information after the component information is stored in the component information storage unit 413.

The collection module 402 collects the version information about the elements from the components composing the control system 2 including the HMI 4 (S11). The collection module 402 outputs a request for the version information about the elements to each component, and collects the version information about the elements from each component as a replay to the request. The detection module 403 compares the information stored in the component information storage unit 413 with the information in which the component ID is associated with the version information collected by the collection module 402 to determine whether there is a difference between the two pieces of information (S12). In other words, the control unit 40 determines whether any component is added or deleted and whether the version information is changed after the component information is stored in the component information storage unit 413. The collection module 402 may collect, from each component, the information in which the component ID and the version information are associated with each other.

If the difference is present (Yes at S12), the storage module 401 renews the component information storage unit 413 (S13). The output module 404 outputs the information indicating the difference to the display 42, and the control unit 40 causes the display 42 to display the information indicating the difference (S14), and ends the processing. If no difference is present at the processing at S12 (No at S12), the control unit 40 skips the processing at S13 and S14 to end the processing.

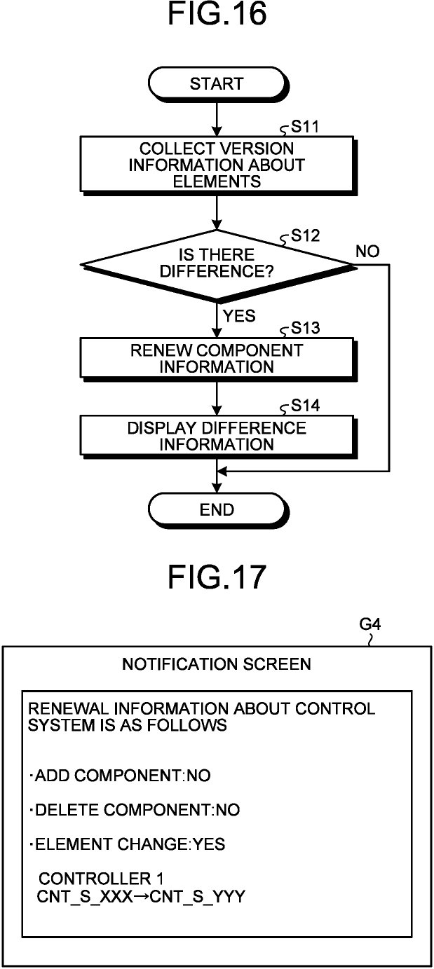

FIG. 17 is a diagram illustrating an example of a notification screen G4 displayed on the display 42 when the detection module 403 detects the difference. The information indicated on the notification screen G4 is an example of the information indicating the difference.

The notification screen G4 displays a message of “the change information about the control system is as follows”, presence or absence of component addition, presence or absence of component deletion, presence or absence of change in element, and the change content are displayed. The example illustrated in FIG. 17 displays that no component is added or deleted, and the version of the element of the controller is changed. Specifically, is it displayed that the version of the software of the controller is changed from “CNT_S_XXX” to “CNT_S_YYY”.

This allows the user to check the renewed component information to notify the vendor of the renewed component information. As a result, the vendor can manage the latest component information. The vendor can renew the system information storage unit 113 of the system configuration information management device 1 on the basis of the component information notified to the vendor.

In the first embodiment, the output module 404 outputs the information indicating the difference to the display 42. The output module 404 may output the information indicating the difference to the system configuration information management device 1 via a network.

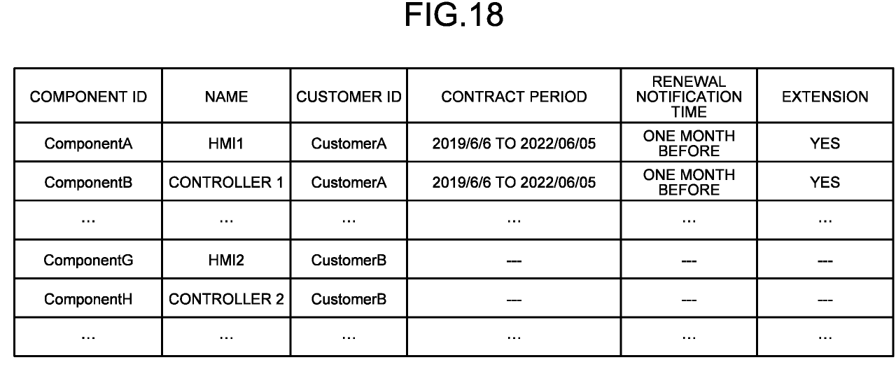

The following describes a modification of the HMI 4. FIG. 18 is a diagram illustrating a data configuration of the contract information storage unit 414. The data configuration of the contract information storage unit 414 includes the extension information in addition to the data configuration (FIG. 4) of the contract information storage unit 112 of the system configuration information management device 1. The extension information indicates whether the component is usable after the contract expiry date. The contract information storage unit 414 is the storage area in which the component identification information in association with the extension information indicating whether the component is usable after the expiry date of the contract period is stored.

The vendor can set the extension information for each component. For example, the vendor makes a setting of extension being not applied so as to limit the use of the component after the contract period expiry when the user may use the component in bad faith after the contract period expiry. For another example, when the vendor permits the user to use the component in the period until renewal of the contract after the contract period expiry, the vendor makes a setting of extension being applied so as not to limit the use of the component immediately after the contract period expiry.

The following describes control based on the extension information. The operation control module 405 controls the operation of the component under the contract on the basis of the extension information stored in the contract information storage unit 414. For example, the operation control module 405 limits, after the expiry date of the contract period, the operation of the component having the extension information in which “is not applied” is stored out of the components after the expiry date of the contract period. The operation control module 405 outputs, to the control unit of the component, an instruction signal to stop a part or the whole of the operation, for example. This allows the operation control module 405 to limit the operation of the component, thereby preventing malicious use by the user.

In contrast, the operation control module 405 does not limit, even after the expiry date of the contract period, the operation of the component having the extension information in which “extension is applied” is stored in the extension information out of the components after the expiry date of the contract period. This allows the component to be continuously usable so as not to cause inconvenience to the user.

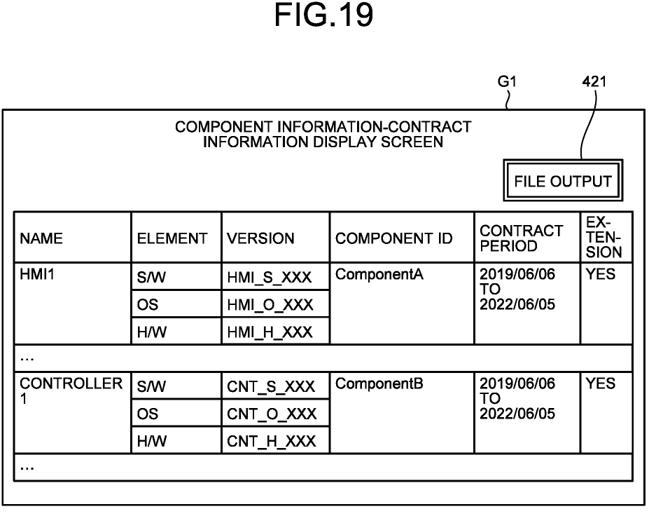

The following describes the component information-contract information display. FIG. 19 is a diagram illustrating a component information-contract information display screen displayed on the display 42 in the modification. When the instruction of the component information-component information display is input in the input device 43, the output module 404 causes the display 42 to display a component information-contract information display screen G1 illustrated in FIG. 19 on the basis of the information stored in the component information storage unit 413 and the contract information storage unit 414.

The component information-contract information display screen G1 displays the file output button 421. When output is instructed by the file output button 421, the control unit 10 instructs an external device such as a printer (not illustrated) to output the content displayed on the component information-component information display screen G1.

The vendor can check the name of each component, the component information, the contract period, and the extension information as needed.

As described above, the HMI 4 in the first embodiment includes the storage device that stores therein the information in which the component information identifying each of the components composing the control system, and the version information indicating the version of the elements of the component having at least the hardware are associated with each other, the collection unit that collects the version information from each of the components composing the control system, and the detection unit that detects a difference between the information stored in the storage device and the information in which the component identification information is associated with the version information collected by the collection unit.

The HMI 4, thus, can recognize the difference between the component information stored in the component information storage unit 413 and the component information actually used in the control system 2.

The HMI 4 in the first embodiment includes the display device that displays the information indicating the difference in the component identification information and the difference in the version information that are detected by the detection unit.

This allows the user to know the difference in the component identification information and the difference in the version information that are detected by the detection module 403. By receiving the notification of the differences from the user, the vendor can grasp the latest component information about the control system 2 and renew the component information managed by the system configuration information management device 1. The HMI 4 can display the information necessary to renew the component information managed by the system configuration information management device 1 on the display 42.

When a trouble occurs in the control system 2, the vendor can easily grasp the latest component information about each component composing the control system 2, thereby making it possible to take quick action on the trouble.

The output module 404 may output the information indicating the differences to the system configuration information management device 1 managed by the vendor. In this case, the vendor can grasp the latest component information about the control system 2 on the basis of the information indicated by the system configuration information management device 1, and can renew the component information managed by the system configuration information management device 1.

The storage device of the HMI 4 in the first embodiment stores therein the component identification information in association with the extension information indicating whether the component is usable after the expiry date of the contract period. The HMI 4 in the first embodiment includes the operation control module that controls the operation of the component after the expiry date on the basis of the extension information.

This allows the HMI 4 to control the operation of the component composing the control system 2 after the contract period expiry date.

### Second Embodiment

A second embodiment is an example where the HMI 4 exchanges data with the system configuration information management device 1 via a gateway 6. In the following description, the description of the same configuration as the first embodiment is omitted.

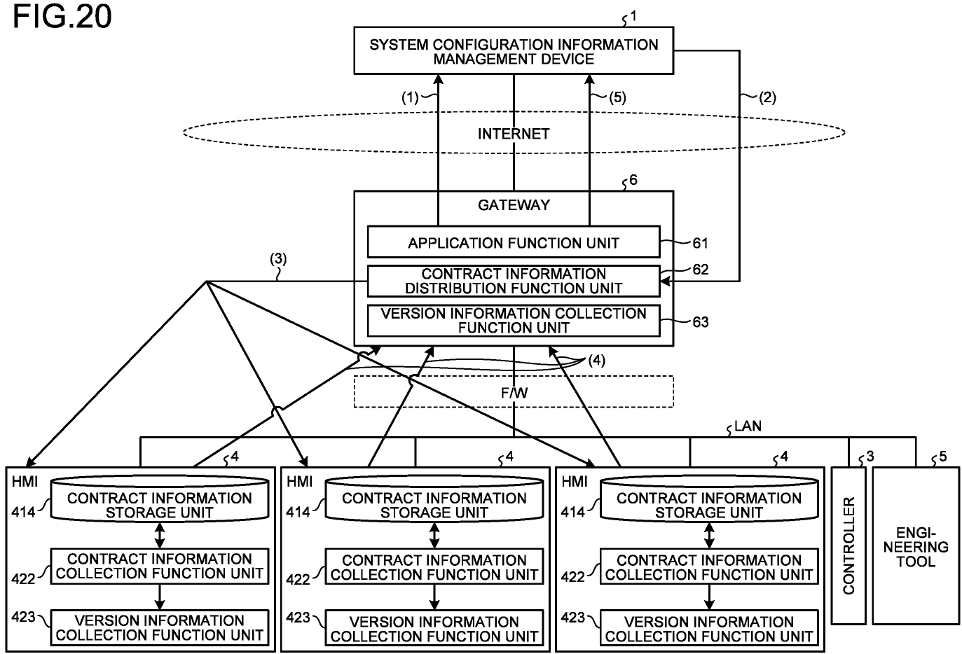

FIG. 20 is a diagram illustrating a data flow in the control system according to the second embodiment. An outline of the control system 2 according to the second embodiment is described with reference to FIG. 20.

The control system according to the second embodiment has the gateway 6 in addition to the controller 3, the HMIs 4, and the engineering tool 5.

As illustrated in FIG. 20, the gateway 6 is a device (gateway device) that relays communication between the components such as the HMIs 4 and the controller 3 in the control system 2 and an external device such as the system configuration information management device 1. Various type of information (e.g., the contract information and the component information) transmitted and received between the components and the system configuration information management device 1 via the gateway 6 are concealed by being encrypted, for example.

In the second embodiment, as illustrated in FIG. 20, the gateway 6 has an application function unit 61, a contract information distribution function unit 62, and a version information collection function unit 63.

The application function unit 61 notifies the system configuration information management device 1 of the component ID declared by the user after the contract for the component is established via a network such as the Internet (operation (1)). In the second embodiment, the application function unit 61 is included in the gateway 6. The application function unit 61, however, may be included in the system configuration information management device 1.

The system configuration information management device 1 assigns the control system ID to the control system including the component having the component ID notified from the application function unit 61. The system configuration information management device 1 transmits the contract information (refer to FIG. 4) about the component having the component ID notified from the application function unit 61 and the component information (refer to FIG. 5) to the gateway 6 (operation (2)).

The contract information distribution function unit 62 receives the contract information and the component information from the system configuration information management device 1 via the network. The contract information distribution function unit 62 distributes the contract information and the component information that are received from the system configuration information management device 1 to the HMIs 4 in the control system 2 via the LAN (operation (3)). The HMIs 4 each write the contract information distributed from the contract information distribution function unit 62 in the contract information storage unit 414, and the component information in the component information storage unit 413.

The version information collection function unit 63 communicates with a version information collection function unit 423 of the HMI 4 to receive the version information about the elements of the component in the control system 2, the version information being collected by the version information collection function unit 423, via the LAN, (operation (4)). In the second embodiment, the version information collection function unit 63 receives the version information collected by the version information collection function unit 423 of any one of the HMIs 4 in the control system 2.

The application function unit 61 transmits the component information (including the version information and the component ID) received by the version information collection function unit 63 from the HMI 4 to the system configuration information management device 1 via the network (operation (5)). In the second embodiment, the application function unit 61 decodes the encrypted version information of the component, and transmits the decoded version information to the system configuration information management device 1. The system configuration information management device 1 determines whether the component information stored in the system information storage unit 113 and the received component information coincide.

When the component information stored in the system information storage unit 113 and the received component information differ from each other, the system configuration information management device 1 renews the component information stored in the system information storage unit 113 to the received component information. The vendor managing the system configuration information management device 1 can easily grasp the versions of the existing elements of each component in the control system 2, thereby making it possible to smoothly renew the elements.

In the second embodiment, the contract information collection function unit 422 of the HMI 4 receives the contract information and the component information from the system configuration information management device 1 via the network such as the Internet. Specifically, the contract information collection function unit 422 receives the contract information and the component information that are distributed by the contract information distribution function unit 62 of the gateway 6. The contract information collection function unit 422 writes the received contract information in the contract information storage unit 414.

The version information collection function unit 423 of the HMI 4 transmits, to the gateway 6 via the LAN, the component information in which the component ID is associated with the version information collected from each component in the control system 2. The version information collection function unit 423 determines whether the component information stored in the component information storage unit 413 and the component information, which includes the version information, collected from each component in the control system 2 coincide.

The version information collection function unit 423 transmits, to the gateway 6 via the LAN, the information about the difference between the component information stored in the component information storage unit 413 and the component information, which includes the version information, collected from each component in the control system.

The control system 2 according to the second embodiment allows the vendor managing the system configuration information management device 1 to easily grasp the versions of the existing elements of each component in the control system 2. As a result, the vendor can smoothly renew the elements.

### Third Embodiment

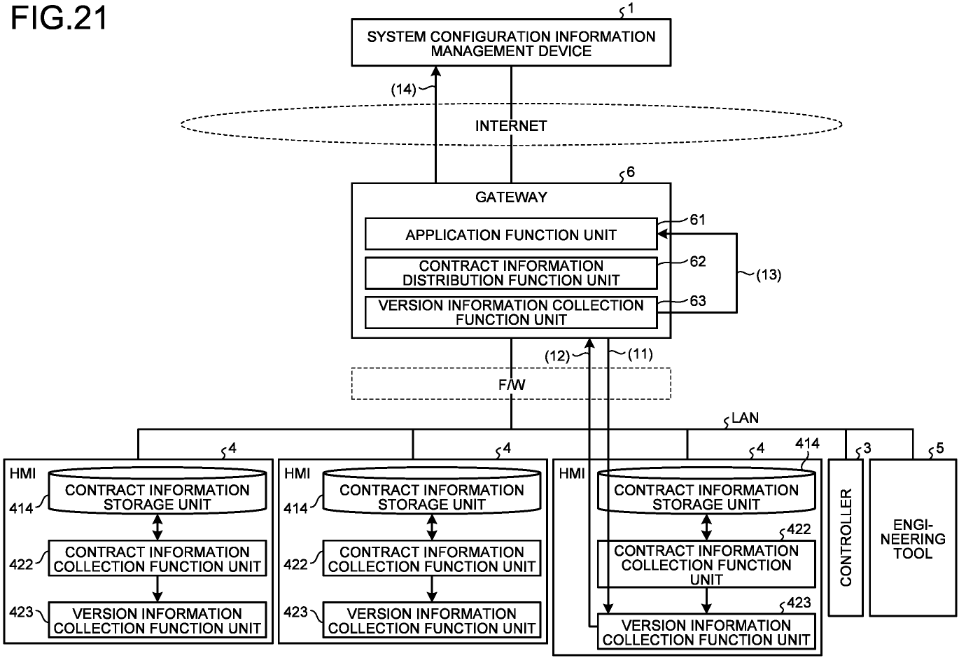

The following describes the control system 2 in a third embodiment. FIG. 21 is a diagram illustrating a data flow in the control system 2 according to the third embodiment. In the third embodiment, the HMI 4 transmits the version information of the component to the gateway 6 at the application time.

The version information collection function unit 63 of the gateway 6 communicates with the version information collection function unit 423 of the HMI 4 to collect the component information including the version information of the component (operation (11) and (12)). The component information is encrypted.

The application function unit 61 of the gateway 6 decodes the component information acquired from the version information collection function unit 63 (operation (13)). In this way, the application function unit 61 acquires the component information about all of the components in the control system 2.

The application function unit 61 of the gateway 6 transmits the component information to the system configuration information management device 1 at the application time (operation (14)).

As described above, the control system 2 according to the third embodiment can easily and correctly perform the processing such as application from each component to the system configuration information management device 1.

### Fourth Embodiment

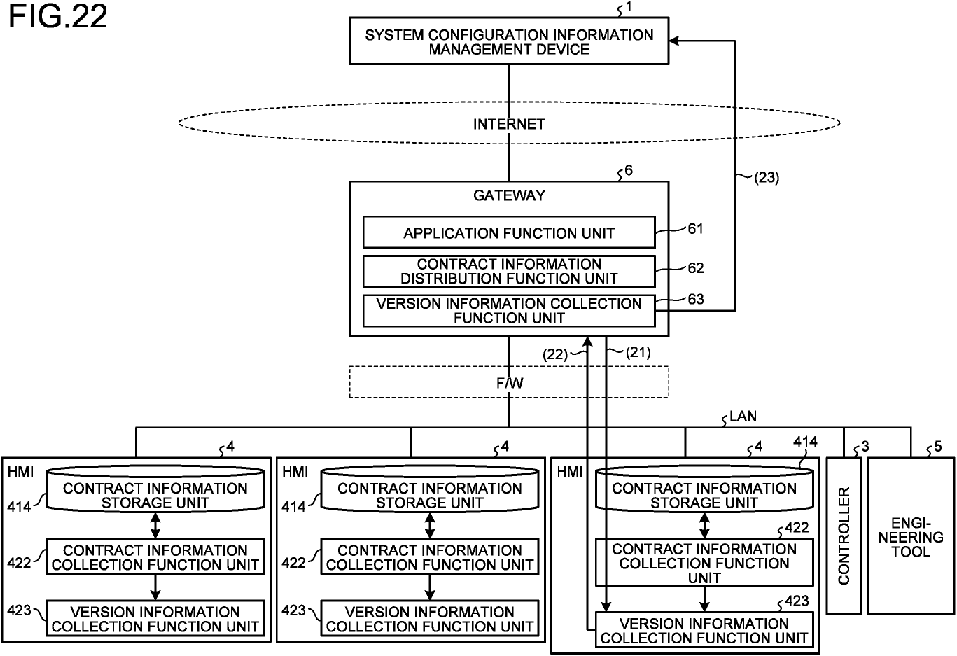

The following describes the control system 2 in a fourth embodiment. FIG. 22 is a diagram illustrating a data flow in the control system according to the fourth embodiment. In the fourth embodiment, the version information about the component is periodically collected by the gateway 6 and transmitted to the system configuration information management device 1.

The version information collection function unit 63 of the gateway 6 periodically communicates with the version information collection function unit 423 of the HMI 4 to collect the component information including the version information about the component (operation (21) and (22)).

The version information collection function unit 63 of the gateway 6 transmits the component information about the component to the system configuration information management device 1.

As described above, the control system 2 according to the fourth embodiment allows the vendor managing the system configuration information management device 1 to consistently grasp the version information about the existing components, and is thus convenient for the vendor.

### Fifth Embodiment

The following describes the control system 2 in a fifth embodiment. In the fifth embodiment, each component includes a contract information storage unit DB that stores therein the contract information transmitted from the system configuration information management device 1, and a restriction control function unit that performs restriction to stop a certain function after lapse of the contract period.

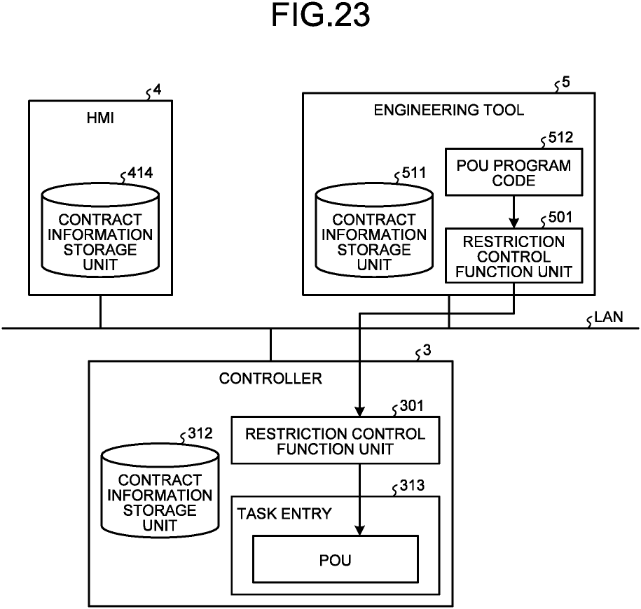

FIG. 23 is a diagram illustrating an outline of the control system 2 according to the fifth embodiment. The HMI 4 includes the contract information storage unit 414 that stores therein the contract information. The controller 3 includes a contract information storage unit 312 that stores therein the contract information including the extension information, and a task entry 313 that stores therein a program organization unit (POU), which is the control program. The controller 3 also includes a restriction control function unit 301, which is achieved by the control unit 30 of the controller 3 as the functional structure.

The engineering tool 5 includes a contract information storage unit 511 that stores therein the contract information including the extension information and a POU program code 512. The engineering tool 5 also includes a restriction control function unit 501, which is achieved by the control unit as the functional structure.

The following describes examples of the restriction. For example, engineering (e.g., registration of the controller 3, design of the POU, and assignment of variables) of the controller 3 is achieved by downloading data to the controller 3 using the dedicated engineering tool 5.

When the POU is downloaded, the restriction control function unit 501 of the engineering tool 5 refers to the contract information storage unit 511, and in a case where the contract period ends and the extension is “not applied”, the restriction control function unit 501 performs the following restrictions 1 and 2.

### Restriction Example 1

The restriction control function unit 501 of the engineering tool 5 performs download (transmission) restriction when the contract period of the engineering tool 5 ends.

### Restriction Example 2

The restriction control function unit 501 of the engineering tool 5 performs the download (transmission) restriction when the contract period of the controller 3 ends.

When the POU is downloaded, the restriction control function unit 301 of the controller 3 refers to the contract information storage unit 312, and in a case where the contract period ends and the extension is “not applied”, the restriction control function unit 301 performs the following restrictions 3 and 4.

### Restriction Example 3

The restriction control function unit 301 of the controller 3 performs download (receiving) restriction when the contract period of the engineering tool 5 ends.

### Restriction Example 4

The restriction control function unit 301 of the controller 3 performs the download (receiving) restriction when the contract period of the controller 3 ends.

As described above, the control system 2 according to the fifth embodiment can stop the function as the restriction in each component when the contract period continues without renewal of the contract and each component of the control system 2 is continued to be used. This is convenient.

The computer program executed by each of the HMIs 4, the controllers 3, the engineering tool 5, the gateway 6, and the like in the embodiments is preliminarily embedded and provided in the ROM, for example. The computer program may be recorded and provided in a computer-readable recording medium such as a compact disc read only memory (CD-ROM), a flexible disk (FD), a compact disc recordable (CD-R), or a digital versatile disc (DVD), as an installable or executable file.

The computer program may be stored in a computer connected to a network such as the Internet and provided by being downloaded via the network. The computer program may be provided or distributed via a network such as the Internet.

The embodiments of the invention are exemplified as described above. The embodiments are only examples and not intended to limit the scope of the invention. These novel embodiments can be implemented in various other forms, and various omissions, replacements, and changes can be made without departing from the gist of the invention. These embodiments and modifications thereof are included in the scope and gist of the invention, and are included in the invention described in the claims and the equivalents thereof.

1. A system configuration information management device, comprising:
a storage device; and
one or more processors coupled to the storage device,
the storage device being configured to store therein control system identification information, component identification information, and version information in association with one another, the control system identification information identifying a control system, the component identification information identifying each of a plurality of components composing the control system, and the version information indicating a version of an element of each of the components having at least hardware.

2. The system configuration information management device according to claim 1, wherein
the one or more processors are configured to assign the control system identification information to a plurality of pieces of the input component identification information, wherein
the storage device is configured to store therein the assigned control system identification information, the component identification information, and the version information.

3. The system configuration information management device according to claim 1, wherein the storage device is configured to store therein the component identification information and information indicating an expiry date of a contract period in association with each other.

4. An operation input device, comprising:
a storage device configured to store therein information including component identification information and version information in association with each other, the component identification information identifying each of a plurality of components composing a control system, and the version information indicating a version of an element of each of the components having at least hardware; and
one or more processors coupled to the storage device and configured to:
a collect the version information from each of the components composing the control system; and
detect a difference between the information stored in the storage device and information in which the component identification information is associated with the collected version information .

5. The operation input device according to claim 4, further comprising a display device configured to display information indicating a difference in the component identification information and a difference in the version information, the differences being detected by the one or more processors.

6. The operation input device according to claim 4 , wherein the information stored in the storage device is either information input from an input device or information received from an external device.

7. The operation input device according to claim 4, wherein
the storage device is configured to store therein the component identification information and extension information in association with each other, the extension information indicating whether each of the components is usable after an expiry date of a contract period, and
the one or more processors are configured to control an operation of each of the components after the expiry date on a basis of the extension information.
